(19) United States
(12) Patent Application Publication
(10) Pub. No.: US 2009/0100452 A1
(43) Pub. Date: Apr. 16, 2009

(54) Interactive multi-media system

(76) Inventors: Brandon Lee Hudgeons, Austin, TX (US); Marcus Adam Shaftel, Austin, TX (US); Julia Heard, Austin, TX (US); Jefferson Blake West, Austin, TX (US); Christopher Cavello, Austin, TX (US)

Correspondence Address: Raymond M Galasso;Simon Galasso & Frantz, P O Box 26503, Austin, TX, 78755-0503, US

(21) Appl. No.: 10/516,724

(22) PCT Filed: May 1, 2003
(86) PCT No.: PCT/US2003/013745

§ 371 Date: Oct. 27, 2008

Related U.S. Application Data
(60) Provisional application No. 60/376,923, filed on May 1, 2002.

(51) Int. Cl. H04H 60/33

(52) U.S. Cl. 725/9

(57) ABSTRACT

An interactive multi media system comprising a display capable of displaying multi media information, one or more input central devices capable of enabling one or more users to interact with the multi media information and characterized by an interactive engine including an application programmer's interface having a format interpreter capable of enabling a programmer to combine multiple multi media formats for display on the display.

### CROSS REFERENCE TO RELATED APPLICATIONS

This application claims priority to co-pending U.S. Provisional Patent Application having Ser. No. 60/376,923 filed May 1, 2002 entitled “Interactive Multi-Media System”, having common applicants herewith.

### FIELD OF THE DISCLOSURE

The disclosures made herein relate generally to data processing systems and more particularly to an interactive multi-media system.

### BACKGROUND

An interactive multi-media system comprises a combination of hardware and software in a manner that enables interactive experiences. Minimal elements of an integrated interactive multi-media system are a display capable of showing multimedia assets, one or more input devices that allow interaction between users and the interactive multi-media system, and an Application Programmer's Interface (API) that allows interactive multimedia designers to design interactive experiences, such as games, business presentations, educational presentations, etc. Some interactive multimedia systems also include one or more additional elements that for supporting the capability of installation-to-installation communication (e.g., between two or more auditoriums), thereby allowing distributed multi-media experience participation (e.g., distributed gaming). Furthermore, some interactive multi-media systems have the ability to act as point-of-sale (POS) systems by facilitating product orders.

Various configurations of personal computer systems, personal gaming consoles and audience response systems are embodiments of conventional interactive multimedia systems. It is known that conventional interactive multi-media systems exhibit one or more limitations with respect to their capability and/or functionality. Examples of such limitations include shortcomings associated with integration of hardware and software enabling the interactive experiences within a single platform, the number of users able to participate in multi-media experiences, the level of distributed multi-media experience participation offered and the level of POS functionality offered.

Personal computer systems typically have a single small display, support only a few simultaneous interactive inputs and support several multimedia APIs. Users can also use personal computers to facilitate POS functionality and implement distributed multi-media experience participation via a network connection (e.g., the Internet). Personal computer systems are not well suited, or generally intended, for providing interactive multi-media functionality to large groups of individuals (e.g., within a large venue).

Personal gaming consoles such as Microsoft Corporation's Xbox® and Sony Computer Entertainment's Playstation® typically have a single small display, support up to about four simultaneous interactive inputs, and support one proprietary multimedia API. Most personal gaming consoles support distributed multi-media experience participation and at least limited product ordering functionality. The proprietary API's of personal gaming consoles are not well suited for experience designers with limited software programming skills.

Audience response systems consist of installation of a hardware solution such as Fleetwood Incorporated's Reply® system in combination with certain software packages (e.g., Advanced Software Products' Digital Professor™ application) that are designed to allow rudimentary presentations or application programs such as Buzztime Entertainment Incorporated's Buzztime™ application. Audience response systems are not integrated interactive multimedia systems, thus an integrated multi-media API is generally not provided in such audience response systems, as it is not necessary or useful to them. Accordingly, distributed multi-media experience participation and point-of-sale capability is typically only available in such audience response systems if third party-software by allows such capability.

Therefore, methods and equipment adapted for facilitating interactive multi-media functionality in a manner that overcomes limitations associated with conventional approaches for facilitating interactive multi-media functionality would be useful.

### BRIEF DESCRIPTION OF THE DRAWING FIGURES

FIG. 1 depicts an interactive multi-media apparatus (IMA) capable of carrying out interactive multi-media functionality in accordance with embodiments of the disclosures made herein.

FIG. 2 depicts an embodiment of various functionality modules comprised by a console of the IMA depicted in FIG. 1.

FIG. 3 depicts an embodiment of an XML-based experience file for implementing a trivia game show.

FIG. 4 depicts an interactive device in accordance with an embodiment of the disclosures made herein.

FIG. 5 depicts an embodiment of an interactive device process flow sequence.

FIG. 6 depicts an embodiment of a method for carrying out interactive experience functionality in accordance with an embodiment of the disclosures made herein.

FIG. 7 depicts an embodiment of the interactive experience creation process depicted in FIG. 6.

FIG. 8 depicts an embodiment of the interactive experience initiation process depicted in FIG. 6.

FIG. 9 depicts an embodiment of the interactive experience query-response process depicted in FIG. 6.

FIG. 10 depicts an embodiment of the POS process depicted in FIG. 6.

### DETAILED DESCRIPTION OF THE DRAWING FIGURES

The disclosures made herein relate to an integrated interactive multi-media platform. An integrated interactive multi-media platform is defined herein to mean an interactive multi-media solution had comprises an integrated combination of functionality that enables interactive experiences to be created and facilitated. Examples of such functionality include large venue presentation functionality, query-response information acquisition functionality, Point-Of-Sale (POS) functionality and distributed interactive experience functionality via inter-installation communication (i.e., communication between multiple interactive multi-media installations).

Methods and/or equipment capable of carrying out functionality in accordance with embodiments of the disclosures made herein enable custom-configured, media-rich interactive experiences to be created and facilitated in a useful and advantageous manner with respect to conventional interactive multi-media systems. In one embodiment of an integrated interactive multi-media platform as disclosed herein, platform components are integrated and adapted for enabling creation of an interactive experience, presenting the interactive experience to a large gathering of people who participate in such interactive experience via one or a few large displays (e.g., a large venue such as a movie theater), for acquiring information relating to the interactive experience in a query-response manner from many interactive devices simultaneously, for providing point-of-sale capabilities in conjunction with the interactive experience and providing distributed participation in the interactive experience via inter-installation communication (e.g., between a plurality of movie theaters). Accordingly, such an integrated interactive multi-media platform overcomes limitations of conventional interactive multi-media solutions, which include shortcomings associated with integration of hardware and software enabling the interactive experiences within a single platform, the number of users able to participate in multi-media experiences, the level of distributed multi-media experience participation offered and the level of POS functionality offered. Furthermore, an integrated interactive multi-media platform as disclosed herein is advantageous in that it has the capability to capture and report detailed statistics on system use (e.g., via participant responses), which greatly assists continuous improvement of interactive experiences.

Through such functionality and capabilities, embodiments of the disclosures made herein advantageously address a number of challenges associated with advertising. This is important as carrying out media-rich interactive experiences in a manner that overcomes shortcomings associated with advertising translated at least partially into financial opportunities. Examples of such challenges include issues associated unengaging audiences, passive audiences, non-active participants, uninterested audiences, delayed action opportunity, quantifying advertising value and generative active negative response. Methods and/or equipment capable of carrying out functionality in accordance with embodiments of the disclosures made herein advantageously address such challenges through tactics such as engaging a captive audience, motivating participants to remain active, presenting rich multi-media content, implementing immediate POS opportunities, capturing real-time audience feedback, and enabling effective business partnerships to be cultivated.

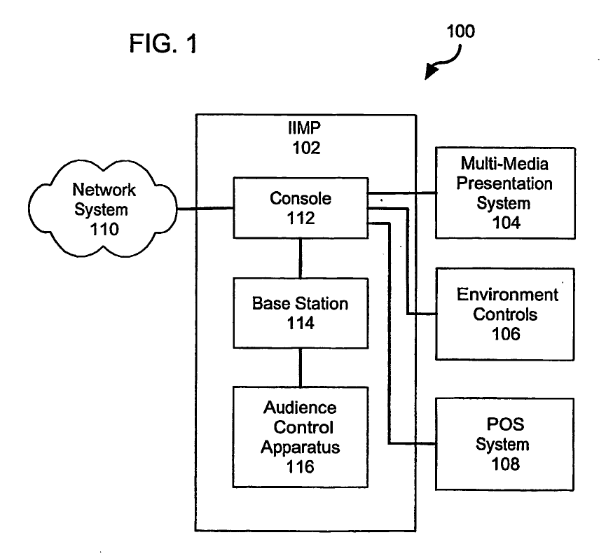

Turning now to discussion of specific drawings, an interactive multi-media apparatus (IMA) 100 capable of carrying out interactive multi-media functionality in accordance with embodiments of the disclosures made herein is depicted in FIG. 1. The IMA 100 comprises an integrated interactive multi-media platform (IIMP) 102 having a multi-media presentation apparatus 104, environment controls 106, a point-of-sale (POS) system 108 and a network system 110 connected thereto. The multi-media presentation apparatus 104 includes a projection system (i.e., a display) and an audio system. A commercially available or proprietary multi-media presentation apparatus (e.g., as used in a movie theater) is an example of the multi-media presentation apparatus 104 depicted in FIG. 1. Lighting controls, climate controls, seating sensation controls and the like are examples of the environment controls 106 depicted in FIG. 1. A commercially available concession POS system is an example of the POS system 108 depicted in FIG. 1. The Internet is an example of the network system 110 depicted in FIG. 1.

The IIMP 102 includes a console 112, a base station 114 and audience control apparatus 116. The IIMP 102 provides an integrated combination of functionality that enables custom-configured, media-rich interactive experiences to be created and facilitated. Examples of such functionality include large venue interactive experience functionality, query-response information acquisition functionality, POS functionality, and distributed interactive experience functionality via inter-installation communication.

The console 112 is placed in relatively close proximity to the multi-media presentation apparatus 104 and, preferably, to the environment controls 106. For example, in a movie theater embodiment, the console 112 is placed in the projection booth where it would be connected to the theater's multi-media presentation system and projection booth controls. Preferably, the console 112 supports all major media types (mp3, mpeg video, avi, QuickTime, Flash, etc) and is capable of serving DVD-quality video and full Dolby® surround sound audio via the multi-media system 104 and an associated sound system, respectively. Additionally, the console 112 locally stores and retrieves interactive multi-media assets such as movie, sound and animation files.

The console 112 interprets interactive experience definition files that specify how associated multimedia assets (e.g., video files, presentation files, text files, animation files, etc) should react to real-time audience participation. Experience definition files and experience definition objects are embodiments of experience information instantiations. The console 112 communicates with the base station 114 to gather audience responses and integrate those responses into facilitation of the interactive experience. The console 112 also tracks and saves audience responses so they can be included in reports, used to improve interactive experiences, or uploaded to scoreboards or databases (e.g., via an Internet server). Additionally, the console 112 connects to point-of-sale (POS) systems of the installation venue, allowing concession ordering via interactive devices (e.g., seat mounted devices) of the audience control apparatus 116. A system of an installation venue (e.g., a venue POS system) that is not part of an interactive multi-media platform is defined herein to be a non-integrated system.

The base station 114 is connected (i.e., coupled) between the console 112 and the audience control apparatus 116. The base station 114 collects gathers input information (e.g., responses) from the audience control apparatus 116 and forwards the input information to the console 112. The base station 114 and the audience control apparatus 116 may be commercially available hardware or proprietary hardware that is capable of providing required functionality. The audience control apparatus 116 includes a plurality of interactive devices readily accessible by an audience of experience participants (i.e., system users). An audience of experience participants is defined herein as a plurality of experience participants who are jointly participating in an interactive experience (e.g., viewing one large movie screen). Preferably, the console 112 and base station 114 support several hundred to thousands of interactive devices, enabling the IIMP 102 to be scalable to relatively large venues.

The console 112 comprises hardware and software components. A data processing system such as a server running a conventional operating system is an example of the hardware component of the console. As discussed in greater detail below, functionality modules configured for and capable of enabling integrated interactive multimedia functionality as disclosed herein comprise respective portions of the hardware and/or software components of the console 112.

In one embodiment, console and server-side software is coded in a Java format, thereby allowing it to be relatively easily ported to essentially all major operating systems. Also in one embodiment, the console 112 implements its own HTTP server to handle communication between the various software components of the console 112. Through implementation of its own HTTP server, multi-location gaming and heterogeneous input devices can be used and integration with other components of the IIMP 102 (e.g., accessory input devices) is as simple as implementing a set of HTTP calls. Sockets can be easily secured and encrypted for sensitive applications.

One embodiment of facilitating communication between the console 112 and other hardware components of the IIMP 102 (e.g., interactive devices of the audience control apparatus 116) includes assigning a unique hierarchical address to each hardware component. An example of such a hierarchical address includes a device type (e.g., 1 byte of information), a device version (e.g., 1 byte of information) and a device identifier (e.g., 2 bytes of information). The hierarchical nature of the address ensures that the console 112 can distinguish between different types and versions of devices and firmware based on address, and that enough address space is available for thousands of devices.

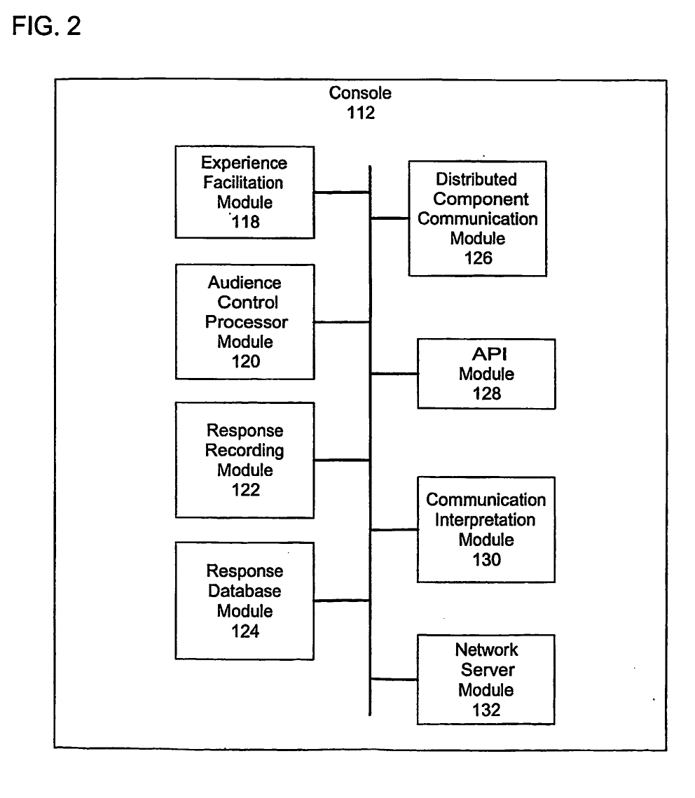

FIG. 2 depicts an embodiment of various functionality modules comprised by the console 112. In the depicted embodiment, the console 112 includes an experience facilitation module 118, an audience control processing module 120, a response processing module 122, a response database module 124, a distributed component communication module 126, an API (Application Programmers Interface) module 128, a communication interpreter module 130, a network server module 132 and an ancillary system integration module 134. The functionality modules are integrated (e.g., inter connected via a common bus) for enabling interaction therebetween.

The experience facilitation module 118 performs processes for carrying out the interactive experience. Broadly speaking, the experience facilitating is the experience engine that tie together experience functionality for enabling the interactive experience to be facilitated in accordance with an associated interactive experience file. Examples of operations performed by the experience facilitation module processes include interpreting interactive experience definition files for specify how associated multimedia assets are outputted, assessing audience feedback, outputting interactive experience information dependent upon audience feedback, processing distributed experience information and the like.

In one embodiment, the experience facilitation module includes various front-end components that facilitate interfacing with the multi-media presentation apparatus 104 and/or the environmental controls. Examples of such front end components include element applets, system CODECs, browser plug-ins and other control/interface components.

The audience control processing module 120 facilitates communication of information between the console 112 and the audience control apparatus 116. The response recording module 122 operates at least partially in conjunction with the response database module 124 for facilitating functionality such as storing responses and enabling response information to be outputted to scoreboard apparatuses.

To facilitate installation, configuration and integration, the software components of the console 112 are organized as a set of discrete distributed components (i.e., software components of the various functionality modules) whose communication is facilitated by the distributed component communication module 126. For example, software components responsible for facilitating presentation of multi-media assets need not even reside on the same integrated multi-media system as the software components responsible for processing interactive experience files or the software components that handle and process interactive device information. In this manner, communication between the various discrete distributed components can be handled through a socket-based messaging system, wherein they are only connected via a common TCP/IP-capable network in order to function as a single unit.

The API module 128 is an interactive experience specification format interpreter. It enables multiple multi-media assets of different instantiation formats (e.g., multi-media file formats) to be integrated into an information instantiation (e.g. an experience definition file) defining a designated interactive experience. The API module 128 is used by an Experience Designer to compose interactive experiences such as interactive games, interactive presentations, interactive educational programs and the like. The API comprises the specification format, instructions and tools that designers use to create an interactive experience.

The specification format of the API is a hierarchical language that allows the Experience Designer to specify specifically which multimedia assets they want to show, the timing of the display, and the way that it will respond to user input. The API supports common interactive situations like quizzes, scoreboards, voting, etc. Extensible Mark-up Language (XML) is an embodiment of a language used for specifying interactive experiences (i.e., an XML-based experience file) implemented via a integrated interactive multi-media platform as disclosed herein.

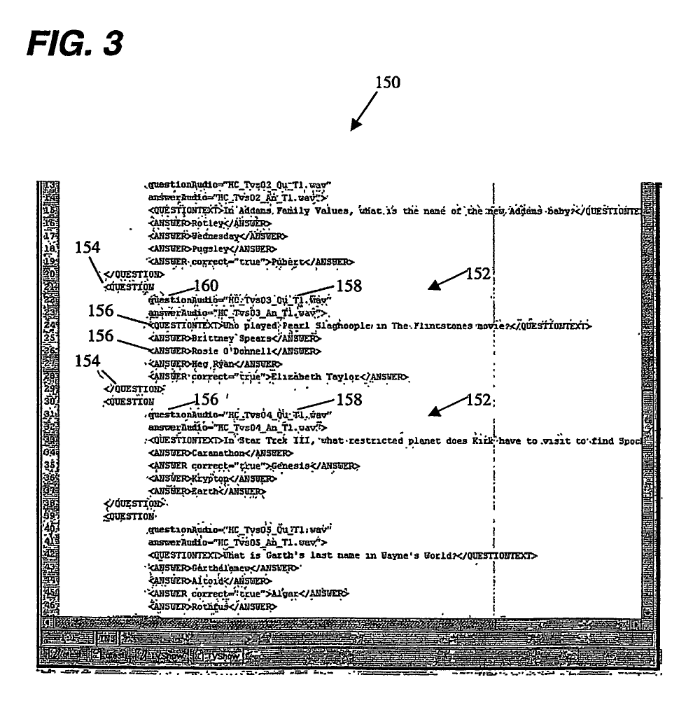

FIG. 3 depicts an embodiment of an XML-based experience definition file 150 for implementing a trivia game show. The experience definition file 150 comprises a plurality of experience segments 152. Each one of the experience segments 152 comprise a plurality of experience segment components such information defining segment context/sequence 154, information defining segment content 156, content (e.g., multi-media assets 158) which may be of different file formats and the like. A set of information presenting a query and responses (including a correct answer) is an example of an experience segment.

An API of the API module 128 facilitates creation of the experience segments 152. Preferably, the API facilitates such creation via a creation wizard (e.g., provided in an API toolbox) that performs such programming in accordance with prescribed rules and functionality. Accordingly the need for manual programming of experiences is precluded.

The experience segments 152 are structured in accordance with a specification format specified by an API of the API module. The specification format designates a structure for assigning each one of the one of the multi-media assets 158 with a type of experience content identifier 160 and for associating the content (e.g., the multi-media assets 158) with corresponding experience segments 152. In this manner, the API and its specification format enable structuring of experience segments and integration of multi-media assets (e.g., audio files) into the interaction experience.

One benefit of the implementing an API as disclosed herein is that it ensures that designers unfamiliar with computer programming can create interactive experiences with tools that are relatively easy and intuitive to use. For example, multimedia artists and/or animators can create interactive experiences using their own familiar tools (i.e., software applications) along with those integrated an IIMP as disclosed herein (e.g., within the API module 130). Or, in an even more simplistic example, a person familiar with a commercially available presentation design program (e.g., Microsoft Corporation's PowerPoint®) can create a presentation using that program, add interactivity with the API of the console 112, and never see a line of code.

The communication interpreter module 130 enables functionality provided by a system external to the IIMP 102 (e.g., the POS system 108) to be integrated with IIMP 102. Through use of functionality provided by the API module 128, communication interpreter modules, such as the communication interpreter module 130 depicted in FIG. 2, can be added to the IMS 100. In this manner, a message from the IIMP 102 can be correctly interpreted and translated into a format (e.g., signal) that can be understood by the POS system 108. Accordingly, this type of functionality and capability makes it easy, for example, for an item ordered at a seat of an interactive experience participant to be automatically added to the participant's (i.e., audience member's) bill. Similarly, an automated lighting system that uses the MIDI show control protocol can be controlled via the IIMP 102, thereby giving experience designers the ability to synchronize light effects with interactive experiences facilitated by the console 112. Preferably, the communication interpreter module 130 is created via the API module 128.

The network server module 132 provides a secure network (i.e., on-line) link to the console 112. Through such link to the console, functionality (e.g., of the console 112 and/or ancillary IMS components) that requires transfer of information over a network connection can be performed. Examples of such ancillary IMS components include remote gaming engines (e.g., distributed gaming systems), remote administration/control components, remote reporting components and the like. The network server One embodiment of the network server module 132 is Internet server software based on J2EE technology, thus making it a convenient interface for interfacing with existing, legacy databases, other online applications, or e-commerce engines.

Examples of functionality enabled by the network server module 132 includes hosting experience-related web sites where game players (i.e., experience participants) register for the game, view past scores and compare results with other players. Another example of such functionality includes enabling experience designers to perform experience development tasks such as securely uploading PowerPoint and multimedia files, adding interactive quizzes and polls to business presentations, and previewing/verifying presentation contents. Still another example of such functionality includes enabling experience participants to view and print reports on quiz scores and poll results. Yet another example of such functionality includes enabling experience designers (e.g., as part of their custom-configured experience) to request that prospective experience participants utilize functionality provided by the network server module 132 to confirm experience reservations and/or to assign seats to confirmed experience participants. Yet another example of such functionality includes serving response data from a database of the console 112 to ancillary IMS components.

Turning now to detailed discussion of base stations and interactive devices, base stations and their corresponding interactive devices (e.g., the base station 114 and interactive devices of the audience control apparatus 116 depicted in FIG. 1) may be wireless or wired. Preferably, each base station interfaces with the console via a common communications port (e.g., a serial port or USB port). Because a particular venue (e.g., a theater) may contain a mix of wired and wireless base station-interactive/device systems and because multiple base stations can be attached to a console, a single console may have many base stations for allowing larger numbers of devices to be served via that particular console. While wireless implementations are faster and easier to install and their associated interaction devices are mobile, wired implementations systems are generally less expensive.

In one embodiment of a wired base station/interactive device system, the wired base station and corresponding interactive devices include a communications component and a power component. The communications component includes a signal level adjustment circuit to accommodate different power levels for communication required by a console, signal boxes and interactive devices. The power component includes a power transformer to convert commonly available electricity levels (e.g. 120V AC) to a low direct current (e.g. 24V DC). The communication and power components connect to a communication bus such as a common wire set (e.g. RJ45) connected between a signal box (i.e., a relay point) and the interactive devices. The signal box relays signals to the wired base station. In one embodiment of the signal box, visual and/or audible identification means is provided for notify service personnel (e.g., wait staff personnel) of a particular location of an experience participant that has requested a POS interaction (e.g., purchase/delivery of food, merchandise, etc).

In one embodiment of a wireless base station/interactive device system, the wireless base station and corresponding interactive devices include each include a receiver/transmitter chipset and communications circuitry that process and adjust signals. The receiver/transmitter pair of the base station communicates with the receiver/transmitter pair of the base station. The base station and interactive devices are powered by a direct current power source such as a transformer or battery power.

Unlike conventional interactive devices (e.g., proprietary handheld interactive devices or temporarily positioned interactive devices), interaction controllers a disclosed herein integrate directly into the environment. For example, in an installation in a movie theater, such interactive devices are shaped like and take the place of a traditional theater seat armrest.

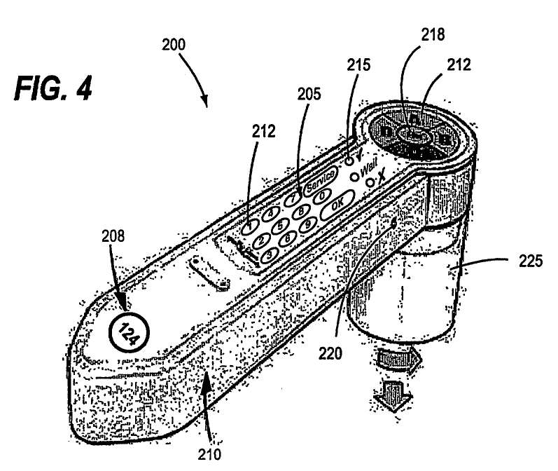

FIG. 4 depicts an interactive device 200 (i.e., a response controller) in accordance with an embodiment of the disclosures made herein. The interactive device 200 is an example of a seat-mounted interaction device in that it is capable of replacing an armrest of a theater seating apparatus. The interaction device 200 is configured for providing integrated interactive, information entry, order request capability, and individual user feedback functionality. Whether wired or wireless, the interactive device 200 includes a keypad user interface 205 (i.e., an input means) connected to control circuitry within a housing of the interactive device 200. A printed circuit board having a microcontroller therein that controls/enables operation of one or more of keypad scanning and communications software, power regulation components and signal processing components is an example of the control circuitry. Preferably, the interactive device 200 includes a visual location identifier 208 (e.g., a seat number) for use in facilitating the interactive experience functionality (e.g., query response, placing POS orders, etc).

The user interface 205 includes a plurality of response buttons 212 (i.e., selectable inputs) and one or more lights 215. The response buttons 212 allow functionality such as experience interaction and POS interaction to be performed via responses made using the response buttons. The one or more lights 215 (e.g., LED's) can be triggered (e.g., by a console) to supply user feedback (i.e., visual user feedback) such as an indication of an ‘OKAY’ status (e.g., order received successfully), a ‘WAIT’ status (e.g., order confirmation pending) or an ‘ADVERSE’ status (e.g., order not accepted or received successfully). The plurality of response buttons 212 and the one or more lights 215 are examples of an information input portion and an information output portion, respectively, of a user interface.

The response buttons 212 of the keypad 205 are used for participating in the interactive experience and/or for facilitating POS functionality. For example, an answer to a question is responded to by pressing one or more keys corresponding to the participants answer. Similarly, the participant may use the response buttons 212 for ordering a food or snack (e.g., entering a number, indicated in a menu, which corresponding to a desired snack).

The keypad 205 includes a specified-item 218 that is used in conjunction with POS functionality. A specified item (e.g. a preferred beverage) of the experience participant is associated with the specified-item button 218. When the specified-item button 218 is depressed, an order for the specified item is automatically placed via an associated POS system. The specified item may be pre-defined or specific to/specified by the experience participant. Not only does this functionality simplify requesting another one of the specified item, but it also precludes the experience participant's attention from diverted a significant degree of their attention away from the interactive experience in which they are participating.

Accordingly, an interactive controller in accordance with an embodiment of the disclosures made herein (e.g., the interactive controller 200 depicted in FIG. 4) enables unique services to a venue such as a theater to be provided. An example of such unique services include integration with POS systems in a manner that allows ‘in-seat’ ordering of concession items (e.g., food and beverages) via the interactive controller 200 depicted in FIG. 4. In a movie theater, for example, concession sales account for the vast majority of theater revenue. But, the concession sales drop sharply after the start of a movie because patrons can't get the attention of the wait staff. The combination of POS system integration and in-seat ordering is advantageous and useful, as it provides a convenient, effective and simple means for continuing to order concession items even after the movie starts.

The interactive device 200 includes an expansion port 220, which allows an ‘add-on’ interactive device (like a special-purpose keypad, keyboard or joystick) to be connected to the associated integrated interactive multi-media platform. The additional input device can use the power and communications circuitry of the interactive device 200, thus reducing size, cost and complexity of the add-on interaction device. The interaction device 200 includes a battery compartment 225 for enabling battery power (i.e., primary or back-up power) to be implemented.

An IIMP as disclosed herein may include non-interactive devices that allow a console of the IIMP to control electromechanical relays via an associated base station. For example, an API of the IIMP includes commands that allow a designer to dim or shut off theater lights and/or trigger effects. An electromechanical relay can be either wired or wireless. In one embodiment, they comprise essentially the same components as wired or wireless interactive devices. The exception being that the electromechanical relays will typically not have interactive capabilities and they will include circuitry that activated and deactivates certain actions/functionality based on signals from the console.

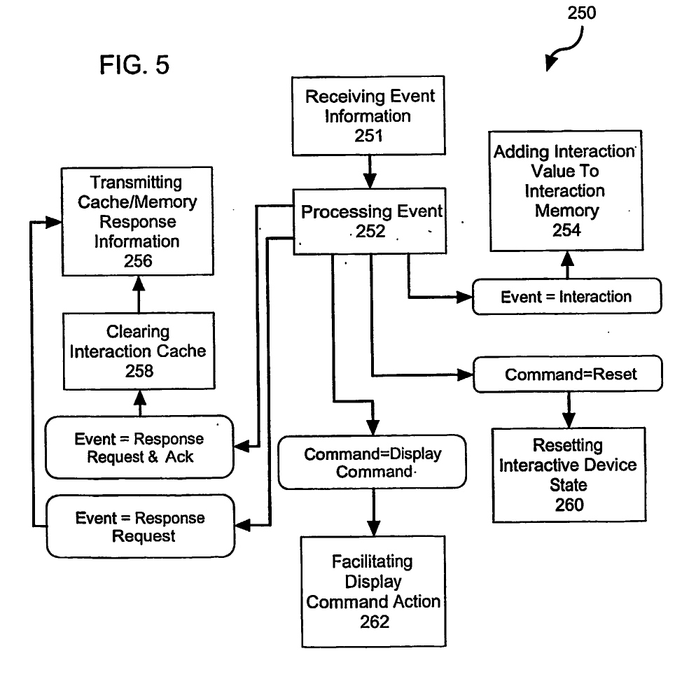

FIG. 5 depicts an embodiment of an interactive device process flow sequence 250 capable of carrying out interaction device functionality as disclosed herein. An audience control apparatus including an interactive device (e.g., the audience control apparatus 116 depicted in FIG. 1) is an example of an apparatus capable of carrying out the interactive device process flow sequence 250 depicted in FIG. 5. In facilitating the interactive device process flow sequence 250, an operation 251 for receiving event information from an interactive device and/or from a data processing system (e.g., the console 112 depicted in FIG. 1). After receiving event information, an operation 252 is performed for processing the corresponding event. Examples of events include interaction events received from the interactive device, command events received from the data processing system and response request events received from the data processing system.

When the event is an interaction event, processing the event includes performing an operation 254 for adding an interaction value corresponding to the interaction event to an interaction memory. When the event is a response request (e.g., in association with a polling operation for gathering responses), processing the event includes performing an operation 256 for transmitting the interaction memory response and/or any interaction cache response for reception by the data processing system. When the event is a response request with receipt acknowledgement, processing the event includes performing an operation 258 for clearing interaction cache in addition to performing the operation 256 for transmitting the interaction memory response and/or any interaction cache response for reception by the data processing system.

When the event is a reset command, processing the event includes performing an operation 260 for resetting a state of the interactive device. Examples of reset states include a state associated with a new experience participant, a state associated with new interface functionality (e.g., a new, updated and/or experience-specific response functionality). When the event is a display command, processing the event includes performing an operation 262 for facilitating the display command. Examples of facilitating the display command include illuminating an LED of the interactive device, de-illuminating an LED of the interactive device and outputting specified information to a display of the interactive device.

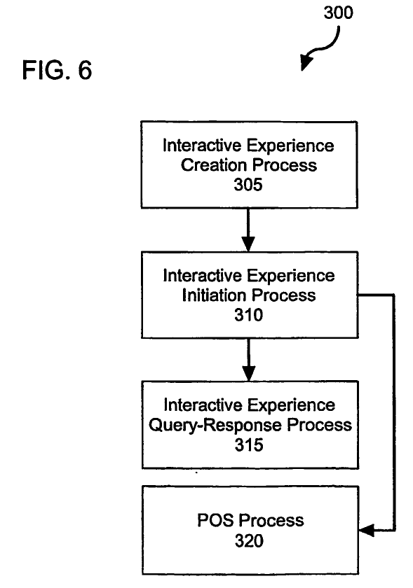

FIG. 6 depicts an embodiment of a method 300 for carrying out interactive experience functionality in accordance with an embodiment of the disclosures made herein. Specifically, the method 300 is configured for carrying out the integrated combination of functionality, discussed above in reference to FIGS. 1 and 2, that enables custom-configured, media-rich interactive experiences to be created and facilitated. A console in accordance with an embodiment of the disclosures made herein (e.g., the console 112 depicted in FIG. 1) is capable of facilitating the method 300 depicted in FIG. 6.

The method 300 includes an interaction experience creation process 305, an interactive experience initiation process 310, an interactive experience query-response process 315 and a POS process 320. The interactive experience creation process 305 is performed for creating an interactive experience definition file that specifies the information defining the interactive experience. After the interactive experience file is created, the interactive experience initiation process 310 is performed to begin facilitation of the interactive experience (i.e., via implementation of the interactive experience definition file), followed by the interactive experience facilitation process 315 being performed for implementing the experience defined in the interactive experience definition file. In this manner, the interactive experience is created and facilitated.

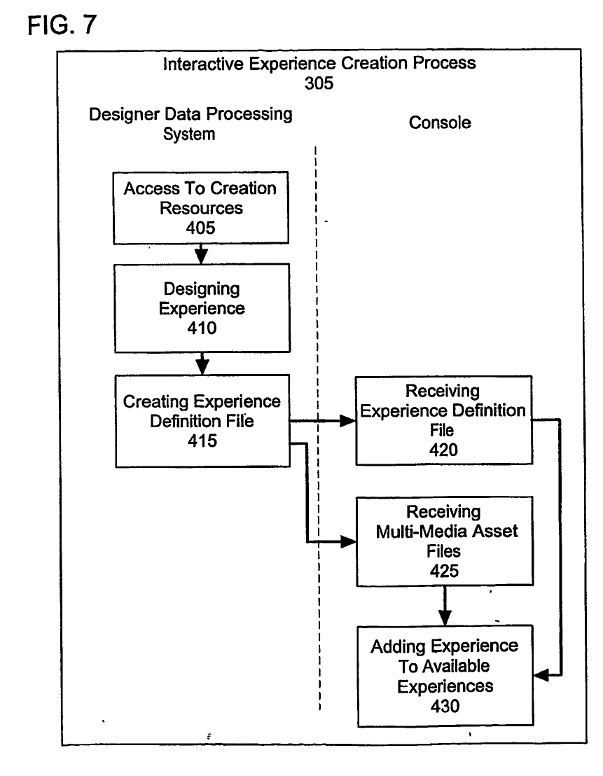

FIG. 7 depicts an embodiment of the interactive experience creation process 305 depicted in FIG. 6. In response to a designer data processing system issuing a request for creating a new interactive experience by a person who desires to create a new interactive experience (i.e., an experience designer), the designer data processing system (e.g., designer personal computer) performs an operation 405 for access to authorized platform-provided creation resources (e.g., content, tools, wizards, etc). The resources may be available locally (e.g., on the designer data processing system), remotely (on the console) or a combination of both. Authorized platform-provided creation resources may include all of or less than available platform-provided creation resources. For example, certain experience designers may have authorization to different platform-provided creation resources than others.

After access the authorized platform-provided creation resources, the designer data processing system performs an operation 410 for facilitating design of an interactive experience data, followed by an operation 415 for creating an experience definition file corresponding to the designed interactive experience. After creating the experience definition file, the console performs an operation 420 for receiving the experience definition file and an operation 425 for receiving multi-media file(s) associated with the experience definition file. Uploading files over a network connection (e.g., via network server software) is an example of receiving the experience definition file and receiving multi-media file(s) associated with the experience definition file. After receiving the experience definition file and receiving multi-media file(s) associated with the experience definition file, console performs an operation 430 for adding the interactive experience to a list of available experiences.

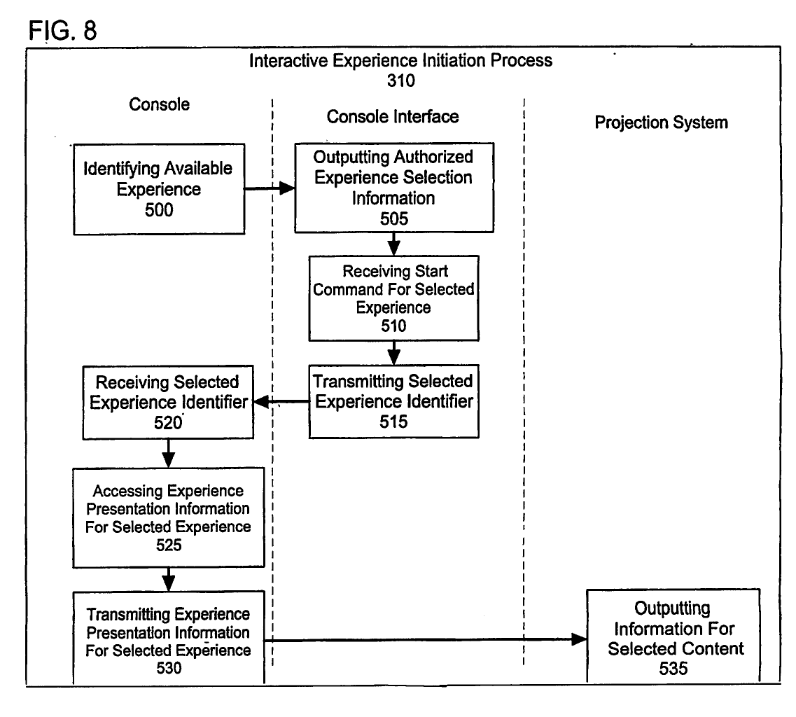

FIG. 8 depicts an embodiment of the interactive experience initiation process 310 depicted in FIG. 6. A console performs an operation 500 is performed for identifying authorized experiences. Authorized experiences may represent all of or less than available experiences. For example, some interactive experiences may not be accessible to all persons authorized to facilitate initiation of interactive experiences (i.e., experience facilitators). In response to the authorized experiences being identified, a console interface performs an operation 505 for outputting (e.g., visually, audibly, etc) authorized experience selection information (e.g., titles, context, length, creator, etc). Examples of outputting include displaying visually, playing audibly and printing. After outputting the authorized experience selection information and in response to the console interface performing an operation 510 for receiving an initiation command for a particular interactive experience (e.g., an experience facilitator selecting a particular selection on a touch screen), the console interface performs an operation 515 for transmitting experience identifier information of the selected interactive experience (e.g., an experience identification code) for reception by the console, followed by the console performing an operation 520 for receiving the experience identifier information of the selected interactive experience.

In response to receiving the experience identifier information of the selected interactive experience, the console performs an operation 525 for accessing experience presentation information of the selected interactive experience (e.g., experience definition file and associated multi-media files). The console performs an operation 530 for transmitting the experience presentation information of the selected interactive experience for reception by a multi-media presentation apparatus after the console accesses the experience information. In response to receiving the experience information, the multi-media presentation apparatus performs an operation 535 for outputting (e.g., visually and audibly) the selected interactive experience to an audience.

The embodiment of the interactive experience initiation process 310 discussed above in reference to FIG. 8 depicts a manual start implementation via a local interface (i.e., the console interface). In another embodiment, the operations performed by the local interface in FIG. 8 are instead performed by a remote interface (e.g., over a network connection), thereby representing a remote start implementation of the interactive experience initiation process. In yet another embodiment, the console receives scheduling information in addition to experience information and the interactive experience is presented in accordance with the scheduling information (e.g., a scheduled start), thereby representing a scheduled start implementation.

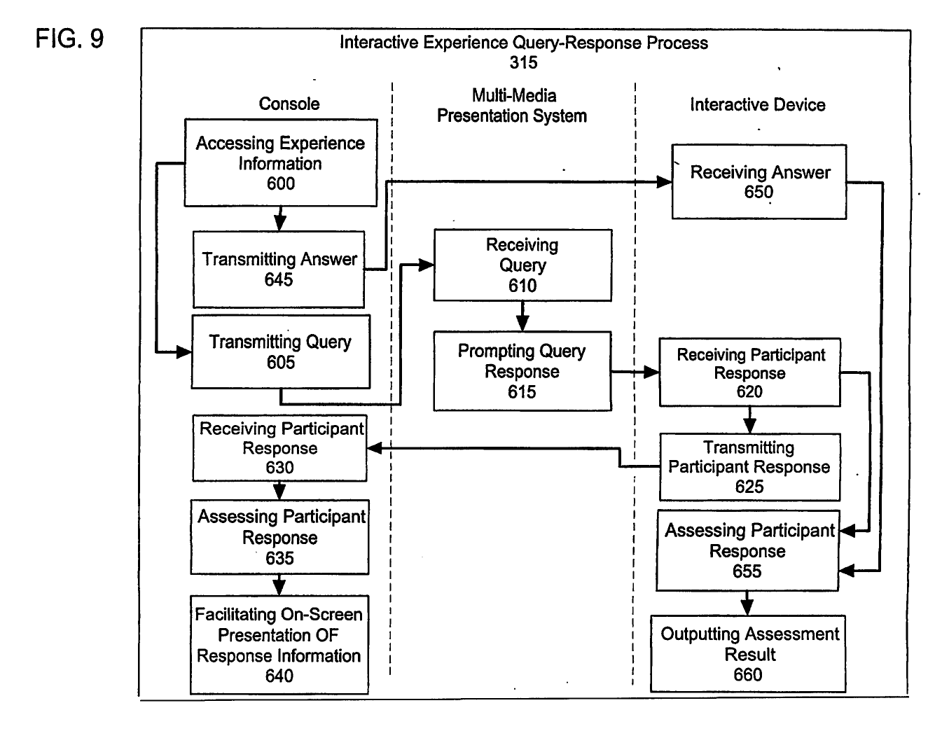

FIG. 9 depicts an embodiment of the interactive experience query-response process 315 depicted in FIG. 6. A console performs an operation 600 for accessing experience information. The experience information includes a query and a correct answer to the query. In response to accessing the experience information, the console performs an operation 605 for transmitting the query for reception by a multi-media presentation system. In response to the multi-media presentation system performing an operation 610 for receiving the query, the presentation system performs an operation 615 for prompting a response to the query (e.g., audibly, visually, etc).

After the presentation system performs the operation 615 for prompting the response to the query, the interactive device performs an operation 620 for receiving a participant response (i.e., the participant enters a response into the interactive device), followed by an operation 625 for transmitting the participant response for reception by the console. After the console performs an operation 630 for receiving the participant response, the console performs an operation 635 for assessing the participant response. Comparing the participant response to a correct response are examples of assessing the participant response. After assessing the participant response, the console performs an operation 640 for facilitating on-screen presentation of response information (i.e., displaying audience-specific information such as correct answer and aggregate scoring).

FIG. 9 depicts a sequence of operations (i.e., an optional sequence of operations) configured for enabling a correctness of the candidate response to be assessed and outputted by the audience device. The sequence of operations begins with the console performing an operation 645 for transmitting the correct answer for reception by the interactive device. In response to the interactive device performing an operation 650 for receiving the answer, the interactive device performs an operation 655 assessing the correctness of the participant response (received at the operation 620) in view of the answer (e.g., correct or incorrect). In response to assessing the correctness of the participant response, an operation 660 is performed for outputting the resulting correctness (e.g., via illumination of a particular LED).

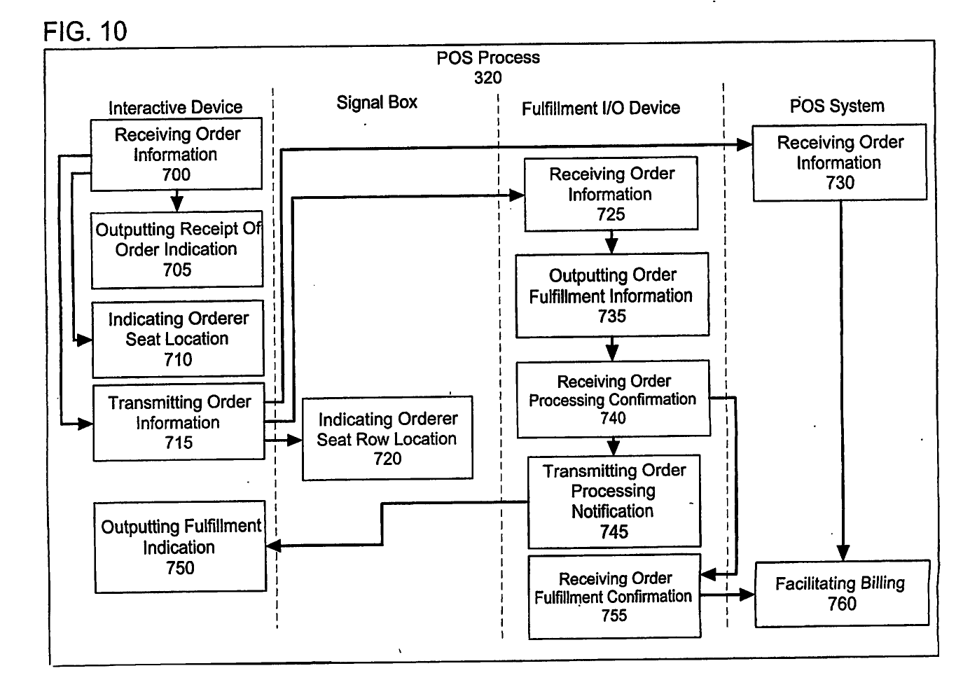

FIG. 10 depicts an embodiment of the POS process 320 depicted in FIG. 6. It is contemplated herein that the POS process 320 capable of being facilitated independent of a theme based interactive experience (e.g., during a conventional presentation of a movie). It is also contemplated that the POS process may be implemented via a system other than an IMS system in accordance with am embodiment of the disclosures made herein (i.e., standalone functionality).

In facilitating the POS process 320, an interactive device performs an operation 700 for receiving order information (e.g., receiving information associated with a theme-based POS opportunity or information associated with a concession item). Examples of order information includes a number indicated in a menu that corresponds to a desired snack and a ‘YES’ reply to an offer for a theme-based POS opportunity. In response to receiving the order information, the interactive device performs an operation 705 for outputting a receipt of order indication (e.g., illuminating a corresponding LED on the interaction device), an operation 710 for indicating an orderer seat location (e.g., illuminating a corresponding LED on the interaction device) and an operation 715 for transmitting the order information for reception by the venue's POS system and by a fulfillment input-output (I/O) device (e.g., a kitchen touch screen device) In response to transmitting the order information, a signal box (e.g., located at the end of the row of seats) performs an operation 720 for indicating an orderer seat isle (e.g., illuminating a corresponding LED on the signal box). It is contemplated herein that the fulfillment I/O device may be that of the venue's POS system, that of an IMP or a standalone element.

In response to the interactive device transmitting the order information, the fulfillment I/O device performs an operation 725 for receiving the order information and the POS system performs an operation 730 for receiving the order information. The fulfillment I/O device performs an operation 735 for outputting (e.g., displaying) order fulfillment information corresponding to the order information after receiving the fulfillment I/O device. Location of the orderer (e.g., a seat number), contents of the order, credit card authorization and the like are examples of order fulfillment information. After outputting the order information and after an attendant (e.g., an serving person) performs necessary steps for fulfilling the order, the fulfillment I/O device performs an operation 740 for receiving an order processing confirmation from the attendant (e.g., a touch screen response indicating the order is being delivered). In response to receiving the order processing confirmation, the fulfillment I/O device performs an operation 745 for transmitting an order processing notification, followed by the interactive device performing an operation 750 for outputting an order fulfillment indication (e.g., illuminating a corresponding LED on the interaction device) to notify the orderer that the order is in the process of being fulfilled (i.e., delivered).

After the order processing confirmation is received and in conjunction with the attendant delivering the order (e.g., before or after the order is delivered), the fulfillment I/O device performs an operation 755 for receiving an order fulfillment confirmation (e.g., a touch screen response by the attendant indicating the order has been being delivered). After the fulfillment I/O device receives the order fulfillment confirmation, the POS system performs an operation 760 for facilitating billing of the order. In one embodiment, facilitating billing includes billing the order to a credit card tendered by the orderer upon entering the venue. For example, the credit card of the orderer (e.g., a experience participant) is associated with a seat of the orderer upon purchase of a ticket with the credit card, at a remote station (e.g., of the venue's POS system or IMS) after the tickets are purchased or via the orderer's interactive device. Accordingly, multiple orders by the orderer can be billed individually by the POS system or can be aggregated by the POS system and billed as a single order.

Referring now to computer readable medium in accordance with embodiments of the disclosures made herein, methods, processes and/or operations as disclosed herein for enabling interactive experience functionality are tangibly embodied by computer readable medium having instructions thereon for carrying out such methods, processes and/or operations. In one specific example, instructions are provided for carrying out the various operations of the methods, processed and/or operations depicted in FIGS. 5 through 8. The instructions may be accessible by one or more processors (i.e., data processing devices) of a console as disclosed herein (i.e., a data processing system) from a memory apparatus of the console (e.g. RAM, ROM, virtual memory, hard drive memory, etc), from an apparatus readable by a drive unit of the console (e.g., a diskette, a compact disk, a tape cartridge, etc) or both. Examples of computer readable medium include a compact disk or a hard drive, which has imaged thereon a computer program adapted for carrying out interactive experience functionality as disclosed herein.

In summary, integrated interactive multi-media platform as disclosed herein has applicability and usefulness to a wide variety of types of interactive experiences. Innovative forms of entertainment represent a first type of such interactive experience that is well matched to the functionality provided by an integrated interactive multi-media platform as disclosed herein. The flexibility of an integrated interactive multi-media platform as disclosed offers the opportunity to explore new forms of interactive group entertainment, which take advantage of theater installations. Examples of interactive experiences for entertainment include interactive, pre-movie game shows; sports trivia and “guess the next play” games during live sports broadcasts; private party/event programming entertainment (e.g., special games with themes dealing with marriage for wedding showers, children for baby showers, children's birthday parties, etc.); new forms of live entertainment; new forms of interactive movies and interactive fiction; and gambling/Bingo implementations.

Business presentations represent another well-matched type of interactive experience for an integrated interactive multi-media platform as disclosed herein. As discussed above, an integrated interactive multi-media platform as disclosed herein (i.e., a console thereof) is capable of reading, interpreting and enabling display of a wide variety of presentation files (e.g., Microsoft® PowerPoint® files). Combining this capability with rich media and interactivity yields applications in large group teleconferencing, meeting facilitation, and event management.

An integrated interactive multi-media platform as disclosed herein is useful in educational applications such as distance learning, education collaboration and real-time testing. Educational classes that are hosted in movie theaters (e.g., certification programs, defensive driving programs, etc) are specific examples of educational applications for which an integrated interactive multi-media platform as disclosed herein is useful. From a physical installation standpoint within a particular environment, an integrated interactive multi-media platform as disclosed herein has possible uses in educational environments such as schools and museums.

Another application in which an integrated interactive multi-media platform as disclosed is useful is research via gathering, storing, using and reporting audience (i.e., interactive experience participant) feedback in real time. Most basically, the platform can be used to perform traditional polls of audiences. However, a more complex implementation of market research includes displaying information that a researcher wants to evaluate and facilitating a query-response evaluation (e.g., via standard and/or add-on interactive devices) as the audience watches the displayed information. In this manner, timing of responses during the interactive experience can be recorded, allowing the researcher to review and evaluate aggregate or individual audience responses in real-time (i.e., a context-specific manner).

Implementation of an interactive device that includes an expansion port enables research that includes physiological information (e.g., pulse rate, skin temperature, skin galvanic response, etc). The expansion port enables a suitable device to be utilized for gathering such physiological information. Physiological Response Measurement (PRM) technology is an example of a technology capable of gathering physiological information. It is contemplated herein that a suitable configured finger cuff is plugged into the expansion port of interactive devices such that the console of the IIMP can record changes in specific experience participants or all participants in a particular experience. By recording and reporting this physiological information, market researchers can gather real-time, direct physiological evidence of an audience's emotional response.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical, mechanical, methodology and electrical changes may be made without departing from the spirit or scope of the invention. For example, operational and/or functional blocks shown in the figures could be further combined or divided in any manner without departing from the spirit or scope of the invention. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. An interactive multi-media system, comprising:
a console configured for facilitating an interactive experience via a multi-media presentation apparatus, wherein the interactive experience is defined by an information instantiation integrating multiple multi-media assets of different instantiation formats and wherein the interactive experience requires facilitation of query-response between an audience of experience participants and the console; and
an audience control apparatus coupled to the console and capable of facilitating said query-response functionality.

2. The interactive multi-media system of claim 1 wherein:
the console includes an Application Programmer's Interface (API) configured for facilitating creation of the information instantiation defining the interactive experience.

3. The interactive multi-media platform of claim 2 wherein the API module facilitates each one of said multi-media assets being assigned a corresponding type of experience content identifier and each one of said multi-media assets being associated with a designer-specified experience segment, thereby enabling integration of multi-media assets of different instantiation formats into the interaction experience.

4. The interactive multi-media platform of claim 2 wherein:
the API module creates an experience segment including a plurality of
experience segment components,
different instantiation formats; and
the experience segment is structured in accordance with a specification format specified by an API of the API module.

5. The interactive multi-media platform of claim 4 wherein the specification format designates a structure for:
assigning each one of said multi-media assets with a corresponding type of experience content identifier; and
associating said multi-media assets with a corresponding experience segment, thereby enabling integration of said multi-media assets into the interaction experience.

6. The interactive multi-media platform of claim 1 wherein:
the console includes an Application Programmer's Interface (API) module;
the API module includes a specification format for defining an interactive experience, wherein the specification format enables multiple multi-media assets of different instantiation formats to be integrated in the information instantiation defining the interactive experience.

7. The interactive multi-media platform of claim 6, further comprising:
a distributed component communication module configured for enabling communication between the API module and other platform modules.

8. The interactive multi-media platform of claim 6, further comprising:
a communication interpretation module configured for enabling information transmitted for reception by an non-integrated system to be translated into a format that can be interpreted by a non-integrated system.
interpretation module is configured by the API module and wherein the interactive experience is at least partially dependent upon transmitting said information for reception by the non-integrated system.

10. The interactive multi-media platform of claim 9, further comprising:
a distributed component communication module coupled to the API module and the communication interpretation module, wherein the distributed component communication module provides enabling communication between the API module and the communication interpretation module.

11. The interactive multi-media platform of claim 6, further comprising:
a network server module accessible configured for providing network connectivity for enabling uploading of information by the said multi-media assets from a remote system and the information instantiation defining the interactive experience.

12. The interactive multi-media platform of claim 6, further comprising:
an audience control processor module configured for enabling communication between a console and an audience control apparatus.

13. The interactive multimedia system of claim 1, further comprising:
a POS system coupled to the console and configured for providing POS functionality, wherein the console further includes a communication interpretation module configured for enabling information transmitted from the console for reception by the POS system to be translated into a format that can be interpreted by the POS system.

14. An interactive multi-media platform, comprising:
an Application Programmer's Interface (API) module providing a specification format for defining an interactive experience, wherein the specification format enables multiple multi-media assets of different instantiation formats to be integrated for enabling creation of an information instantiation defining the interactive experience.

15. The interactive multi-media platform of claim 14, further comprising:
a distributed component communication module configured for enabling communication between the API module and other platform modules.

16. The interactive multi-media platform of claim 14, further comprising:
a communication interpretation module configured for enabling information transmitted for reception by an non-integrated system to be translated into a format that can be interpreted by a non-integrated system.

17. The interactive multi-media platform of claim 16 wherein the communication interpretation module is configured by the API module and wherein the interactive experience is at least partially dependent upon transmitting said information for reception by the non-integrated system.

18. The interactive multi-media platform of claim 17, further comprising:
a distributed component communication module coupled to the API module and the communication interpretation module, wherein the distributed component communication module provides enabling communication between the API module and the communication interpretation module.
a network server module accessible configured for providing network connectivity for enabling uploading of information by the said multi-media assets from a remote system and the information instantiation defining the interactive experience.

20. The interactive multi-media platform of claim 14, further comprising:
an audience control processor module configured for enabling communication between a console and an audience control apparatus.

21. An interactive multi-media system, comprising:
a display capable of displaying multi-media information;
one or more input central devices capable of enabling one or more users to interact with the multi-media information; and
characterized by an interactive engine including an Applications Programmer's Interface (API) having a format interpreter capable of enabling a programmer to combine multiple multi-media formats for display on said display.

22. A method, comprising:
creating an information instantiation defining an interactive experience adapted for being facilitated via an interactive multi-media platform, wherein the information instantiation defines the interactive experience and integrates multiple multi-media assets of different instantiation formats; and
facilitating the interactive experience after the information instantiation defining the interactive experience is created, wherein said facilitating the interactive experience includes implementing query-response functionality between an audience of experience participants and the interactive multi-media platform in accordance with the information instantiation.

23. The method of claim 22 wherein:
creating the information instantiation includes accessing an Application Programmer's Interface (API); and
the API providing a specification format for defining interactive experiences;
the specification format enables said multiple multi-media assets of different instantiation formats to be integrated in the information instantiation defining the interactive experience.

24. The method of claim 23, further comprising:
uploading the said multi-media assets from a remote data processing system after said creating the information instantiation is complete.

25. The method of claim 24, further comprising:
uploading the information instantiation defining the interactive experience.
from a remote data processing system after said creating the information instantiation is complete.

26. The method of claim 22 wherein implementing said query-response functionality includes presenting a query to an audience of experience participants and prompting a query response.

27. The method of claim 26, further comprising:
receiving query responses from at least a portion said experience participants after prompting the query response, wherein at least a portion of said query responses are received from different interactive devices.

28. A method, comprising:
accessing an information instantiation defining an interactive experience, wherein the information instantiation defines the interactive experience and integrates multiple multi-media assets of different instantiation formats;
presenting the interactive experience to an audience of experience participants via an interactive multi-media platform, wherein presenting the interactive experience includes presenting a query to an audience of experience participants and prompting a query response; and
receiving query responses from at least a portion said experience participants after prompting the query response, wherein at least a portion of said query responses are received from different interactive devices.

29. A computer readable medium, comprising:
instructions processable by at least one data processing device; and
an apparatus from which said instructions are accessible by said at least one data processing device;
wherein said instructions being adapted for enabling said at least one data processing device to facilitate:
creating an information instantiation defining an interactive experience adapted for being facilitated via an interactive multi-media platform, wherein the information instantiation defines the interactive experience and integrates multiple multi-media assets of different instantiation formats; and
facilitating the interactive experience after the information instantiation defining the interactive experience is created, wherein said facilitating the interactive experience includes implementing query-response functionality between an audience of experience participants and the interactive multi-media platform in accordance with the information instantiation.

30. The computer readable medium of claim 29 wherein:
creating the information instantiation includes accessing an Application Programmer's Interface (API); and
the API providing a specification format for defining interactive experiences;
the specification format enables said multiple multi-media assets of different instantiation formats to be integrated in the information instantiation defining the interactive experience.
enabling said at least one data processing device to facilitate:
uploading the said multi-media assets from a remote data processing system after said creating the information instantiation is complete.

32. The computer readable medium of claim 31 said instructions are further adapted for enabling said at least one data processing device to facilitate:
uploading the information instantiation defining the interactive experience.
from a remote data processing system after said creating the information instantiation is complete.

33. The computer readable medium of claim 29 wherein implementing said query-response functionality includes presenting a query to an audience of experience participants and prompting a query response.

34. The computer readable medium of claim 33 said instructions are further capable of enabling said at least one data processing device to facilitate:
receiving query responses from at least a portion said experience participants after prompting the query response, wherein at least a portion of said query responses are received from different interactive devices.

35. A computer readable medium, comprising:
instructions processable by at least one data processing device; and
an apparatus from which said instructions are accessible by said at least one data processing device;
wherein said instructions being adapted for enabling said at least one data processing device to facilitate:
accessing an information instantiation defining an interactive experience, wherein the information instantiation defines the interactive experience and integrates multiple multi-media assets of different instantiation formats;
presenting the interactive experience to an audience of experience participants via an interactive multi-media platform, wherein presenting the interactive experience includes presenting a query to an audience of experience participants and prompting a query response; and
receiving query responses from at least a portion said experience participants after prompting the query response, wherein at least a portion of said query responses are received from different interactive devices.

36. An theater seating apparatus, comprising:
an interactive device including a user interface configured for facilitating query-response functionality in association with an interactive experience and for facilitating point-of-sale (POS) functionality from a seat of an experience participant.

37. The theater seating apparatus of claim 36 wherein the user interface includes information input portion and information output portion.

38. The theater seating apparatus of claim 37 wherein:
the information input portion includes a keypad having a plurality of selectable inputs; and
the information output portion includes illumination devices.

39. The theater seating apparatus of claim 37 wherein:
a first portion of said selectable inputs are visually identified as corresponding to respective alpha inputs;
a second portion of said selectable inputs are visually identified as corresponding to respective numeric inputs; and
a third portion of said selectable inputs are visually identified as corresponding to respective designated-service requests.

40. The theater seating apparatus of claim 37 wherein:
a first portion of said selectable inputs are visually identified as being response keys for responding to a query presented to a device user; and
a second portion of said selectable inputs are visually identified as corresponding to respective designated service functionalities.
functionality is one of requesting service from an attendant and placing an order for a pre-determined concession item.

42. The theater seating apparatus of claim 36 wherein the user interface include a selectable input visually identified as corresponding to a designated service request.

43. The theater seating apparatus of claim 42 wherein the designated service functionality is one of requesting service from an attendant and placing an order for a pre-determined concession item.

44. The theater seating apparatus of claim 36 wherein the designated service request is one of requesting service from an attendant and placing an order for a pre-determined concession item.

45. The theater seating apparatus of claim 36 wherein:
the interactive device includes a port for enabling an ancillary device to be electrically connected to the interactive device.
